(19) United States
(12) Patent Application Publication
(10) Pub. No.: US 2008/0261181 A1
(43) Pub. Date: Oct. 23, 2008

(54) System and Method for Learning Languages

(76) Inventors: Guy St. John Kennedy, Western Australia (AU); Matthew John McGinniss, Western Australia (AU); Andrew John Green, Western Australia (AU); Michael Douglas Smith, Western Cape Province (ZA); Damien Christopher Leri, Philadelphia, PA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/914,351

(22) PCT Filed: May 12, 2006
(86) PCT No.: PCT/AU2006/000629

§ 371 Date: May 1, 2008

(30) Foreign Application Priority Data
May 12, 2005 (AU) 2005902391

(51) Int. Cl. G09B 19/06

(52) U.S. Cl. 434/157

(57) ABSTRACT

A language learning system adapted to facilitate the learning of a language by at least a first of two separated users comprising a web-based system which integrates peer-to-peer communications with Voice over Internet Protocol technology to provide one-to-one communication which enables said users to speak in real-time with the intention of taking part in scripted role-play scenarios in the language to be learned which enables the at least first user to practice skills in this language wherein the text of a selected role-play is displayed before each of said users simultaneously with the said speaking in real-time.

### FIELD OF THE INVENTION

The present invention relates to a system and method for learning a foreign language, and specifically, a system and method using peer-to-peer communication over the Internet.

### BACKGROUND ART

Learning a second language is a difficult task, which can be improved by practice and using the language in as many different situations as possible. Being able to find other people with whom you can converse in order to be able to practice can be difficult for a number of reasons. There may not be many people around who are able to speak the same language, or, if they are, are not at the same level. Many people can also find it quite an intimidating process.

The advent of the Internet has provided additional opportunities to enable language learning. Language learning websites provide access to learning communities which provide opportunities to speak to other people. Examples of these are the language forums on www.skype.com, and the Jyve Language Learning Community. The website “MyLanguageExchange” enables speakers of a second language to speak with native speakers in that language who are learning the native language of the other. The leading online English language teaching service “Englishtown” provides access to teacher-led discussions, tailored study plans and student-to-student interaction.

### DISCLOSURE OF THE INVENTION

Accordingly, the invention resides in a language learning system adapted to facilitate the learning of a language by at least a first of two separated people over a communication means adapted to provide two-way communication between the two people, the system comprising means for presenting a scripted dialogue as displayed text to said first user, means for presenting the same scripted dialogue as displayed text to a second user, wherein the communication means enables voice communication between the first and second user simultaneously with the presenting of the scripted dialogue.

According to a preferred feature of the invention, the means for presenting the scripted dialogue as displayed text uses the Internet to present the scripted dialogue as web pages, and the means for enabling voice communication uses a Voice over Internet Protocol application.

According to a preferred feature of the invention, the system is operable to present the scripted dialogue first to the first user prior to enabling voice communication, and is also operable to: receive a first signal from the first user indicating a wish to communicate with the second user, to send a second signal to the second user in response to the first signal indicating the wish to communicate, and to receive a third signal from the second user indicating an acceptance of the wish to communicate, the system being further operable, in response to the third signal, to present the scripted dialogue to the second user, and to launch the Voice over Internet Protocol application.

According to a preferred feature of the invention, the Voice over Internet Protocol application specifies that the second user calls the first-user upon acceptance of the wish to communicate.

According to a preferred embodiment, the system is operable to allocate specific roles in the scripted dialogue to the first and second users, the scripted dialogue being presented to the first and second users with indications of their roles.

According to a preferred embodiment, the system can be further operable to present variations of the scripted dialogue after first presenting the scripted dialogue as a whole.

According to a preferred embodiment, the variations include removing portions of text from the scripted dialogue.

According to a preferred feature of the invention, the system further comprises a server adapted to cause respective web pages to be displayed before the first user and second user at required moments.

According to a preferred feature of the invention, the server provides means to control access to the language learning system by the users.

According to a preferred feature of the invention, the server provides means to monitor and control the interaction of the users with the language learning system and with each other.

According to a preferred feature of the invention, relevant data about a user is recorded within a database associated with the server and may be viewed on a web page by other users.

According to a preferred embodiment, the second user is a teacher who provides time in tutoring a first user as a service for remuneration and wherein the server provides means to record the time spent by a teacher in tutoring a first user.

According to a preferred embodiment, the system provides means to collect payment from the respective first user for time engaged with a teacher and means to disburse payment to a teacher for time spent in tutoring a respective first user.

According to a preferred embodiment, means is provided for a user to provide an indication of the performance of another user with whom he has engaged in a role-play and for the indications for a particular user to be averaged to provide a performance rating for said particular user.

In accordance with a further aspect, the invention resides in a language learning system adapted to facilitate the learning of a language by at least a first of two separated users comprising a web-based system which integrates peer-to-peer communications with Voice over Internet Protocol technology to provide one-to-one communication which enables said users to speak in real-time with the intention of taking part in scripted role-play scenarios in the language to be learned which enables the at least first user to practice skills in this language wherein the text of a selected role-play is displayed before each of said users simultaneously with the said speaking in real-time.

In accordance with a further aspect, the invention resides in a method for learning language in which a scripted dialogue is presented as displayed text to a first and a second user, whilst enabling voice communication between the two users simultaneously.

According to a preferred feature of the invention, the scripted dialogue is presented using web pages over the Internet, whilst the voice communication is enabled using a Voice over Internet Protocol application.

According to a preferred feature of the invention, the scripted dialogue is first presented to the first user, and is only presented to the second user after the first user has issued an invitation to the second user, and that invitation has been accepted by the second user.

According to a preferred feature of the invention, upon acceptance by the second user, the Voice over Internet Protocol application is launched to enable voice communication.

According to a preferred feature of the invention, the voice communication may be enabled by the second user calling the first user.

According to a preferred feature of the invention, wherein once voice communication is established between the first and second users, the scripted dialogue is presented to the user page by page.

According to a preferred feature of the invention, the web pages will be presented to the first user prior to invitation of the second user for a predetermined period of time, and invitation cannot be sent until the first user has been presented with the web pages for the predetermined period of time.

According to a preferred embodiment, variations to the scripted dialogue can be presented to the first and second users after the scripted dialogue has been presented.

According to a preferred embodiment, the variations are the scripted dialogue with portions removed.

According to a preferred embodiment, the variations are suggestions for free communication.

According to a preferred feature of the invention, a user must first log on to a server adapted to monitor and control the interaction of the users prior to being able to engage in communication with other users.

According to a preferred embodiment, relevant data about a user is recorded within a database associated with the server and may be viewed on a web page by other users to thereby enable the first user to select a suitable second user.

According to a preferred feature of the invention, a user is able to provide an indication of the performance of an other user with whom role-play has been conducted and for the indications for a particular user to be averaged to provide a performance rating for said particular user.

According to a preferred embodiment, wherein the second user is a teacher who provides time in tutoring a first user as a service for remuneration and wherein the server provides means to record the time spent by a teacher in tutoring a first user.

According to a preferred embodiment, the server provides means to collect payment from the respective first user for time engaged with a teacher and means to disburse payment to a teacher for time spent in tutoring a respective first user.

According to a preferred embodiment, the server provides means to control access to the language learning system by the users.

In the present invention, a language learning system 10 comprises a web-based system which integrates peer-to-peer (P2P) communications with Voice over Internet Protocol (VoIP) technology to provide one-to-one communication which enables users to speak in real-time with the intention of taking part in scripted role-play scenarios in a foreign language which enable the users to practice their skills in this language.

The use of VoIP and P2P is also well known to persons skilled in the art, and, as mentioned above, need not be described in any further details herein, except as is relevant to the present invention.

Briefly, in the system of the present invention, users of the system 10 access and study written and audio content through a website provided on a remote server 11—in a known manner—using a web browser loaded on a computer or other suitable device. Each user also has a microphone and earphones, USB telephone handset or other suitable device to enable voice communication over the Internet. Users are able to search for, and communicate with—via the website—another user and to engage in conversation with this user, and specifically to work through a scripted role-play and a discussion in a second language for language practice and learning.

Each user also has a VoIP application running on their computer. In the embodiment described herein, this is the Skype™ application—a proprietary application available to download from Skype.com—see www.skype.com.

The operation of the system 10 will now be described in more detail.

The website includes a number of web pages that can be accessed by users. Some will require authentication, some not. Typically, the user will access a Home Page initially which will allow them to register and to log in. In the embodiment described herein, most of the pages require authentication before being accessible—hence the log in feature referred to above.

### BRIEF DESCRIPTION OF THE DRAWINGS

The invention will now be described, by way of example only, with reference to the following drawings, of which:

FIG. 1 is a schematic representation of the main components of the system of the present invention;

FIGS. 2 to 14 and 16 to 31 are illustrations of web pages displayed as part of the present invention; and

FIG. 15 is a schematic representation of the invitation and acceptance step of the present invention.

### BEST MODE(S) FOR CARRYING OUT THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

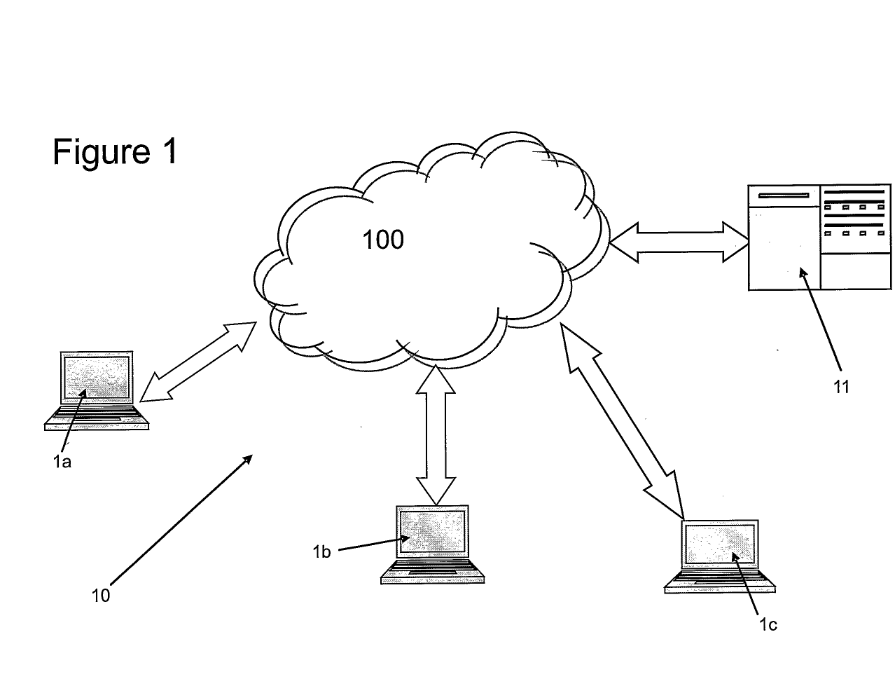

The use of the Internet for communication and the dissemination of information is now well established. FIG. 1 illustrates schematically how individual users 1 having access to a computer or other web-enabled personal communication device can communicate with other users via the Internet 100. In FIG. 1, three users 1a, 1b, and 1c are shown to represent three users of the present invention. The method, configuration and operation of the Internet is well known to persons skilled in the art and need not be described in any further details herein, except in so far as it is relevant to the present invention. The use of the World Wide Web to disseminate information over the Internet and to enable communication and information sharing is also well known to persons skilled in the art, and, again, need not be described in any further detail except as is relevant to the present invention.

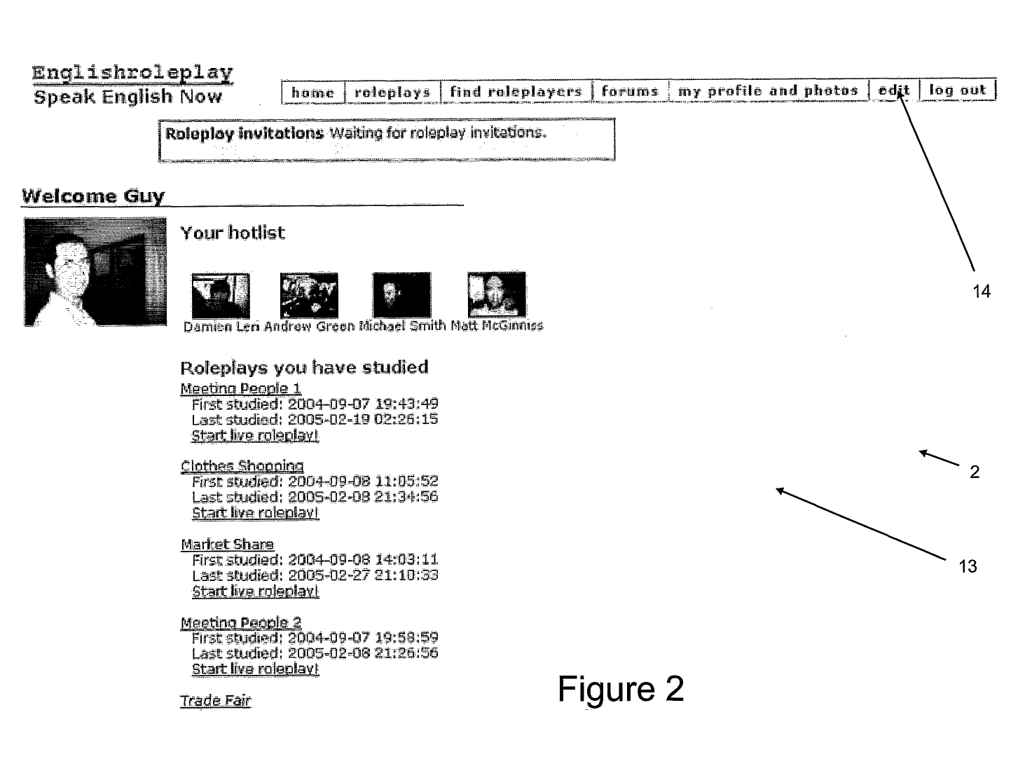

Once a user is logged in, he will be directed to his own Home Page 13—illustrated in FIG. 2. This will typically provide a list of role-play scenarios that he has studied and other information such as the personal details and availability of favorite role-play partners. Links 14 are also provided to other pages—for example to the website homepage, role-plays, role-players, forums, user's profile, and so on.

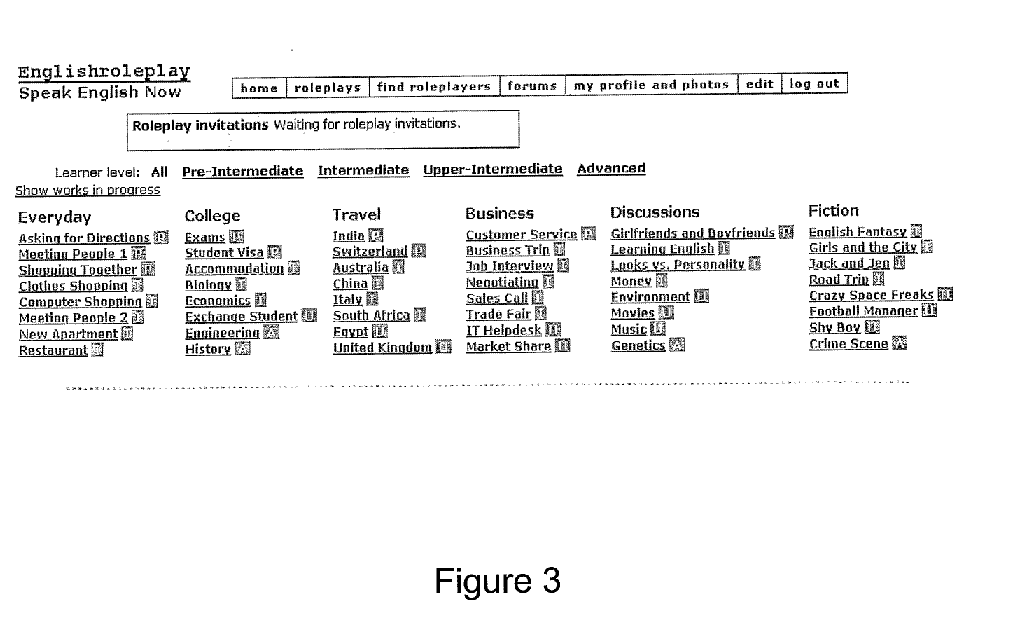

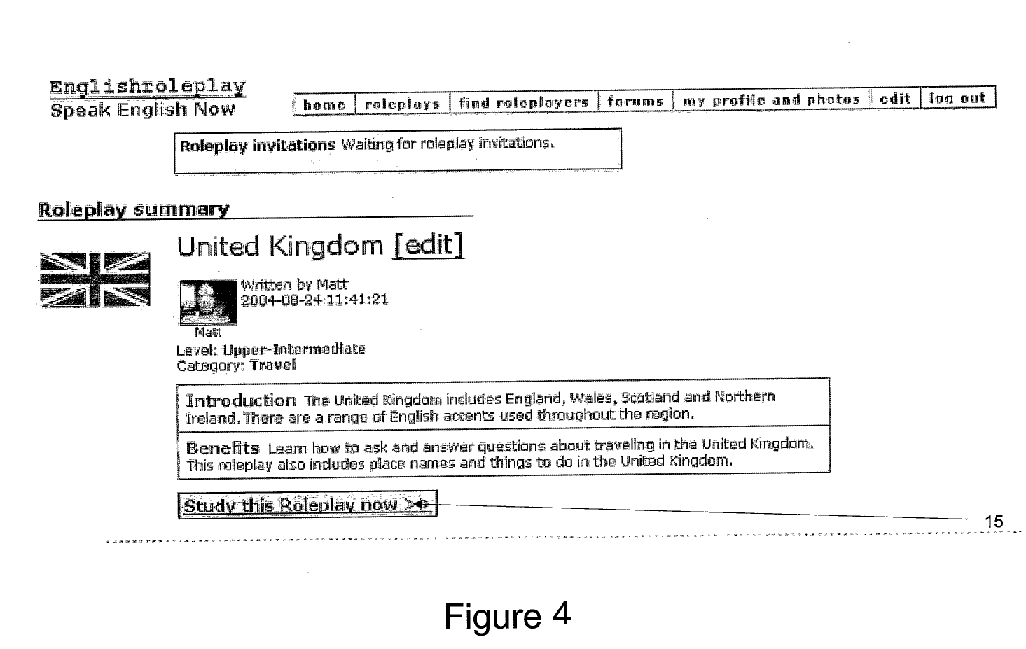

If a user wishes to study a role-play he clicks on the link ‘roleplays’ and this takes him to the ‘roleplays’ page (FIG. 3). Here are listed a number of potential role-plays that he can study—sorted into categories such as Everyday, College, Travel, Business, Discussions and Fiction. To study a role-play the user clicks on the selected role-play, and that takes him to a page introducing the role-play (see FIG. 4 for an example), and giving further information.

If the user wishes to study this role-play, then he clicks on the link 15.

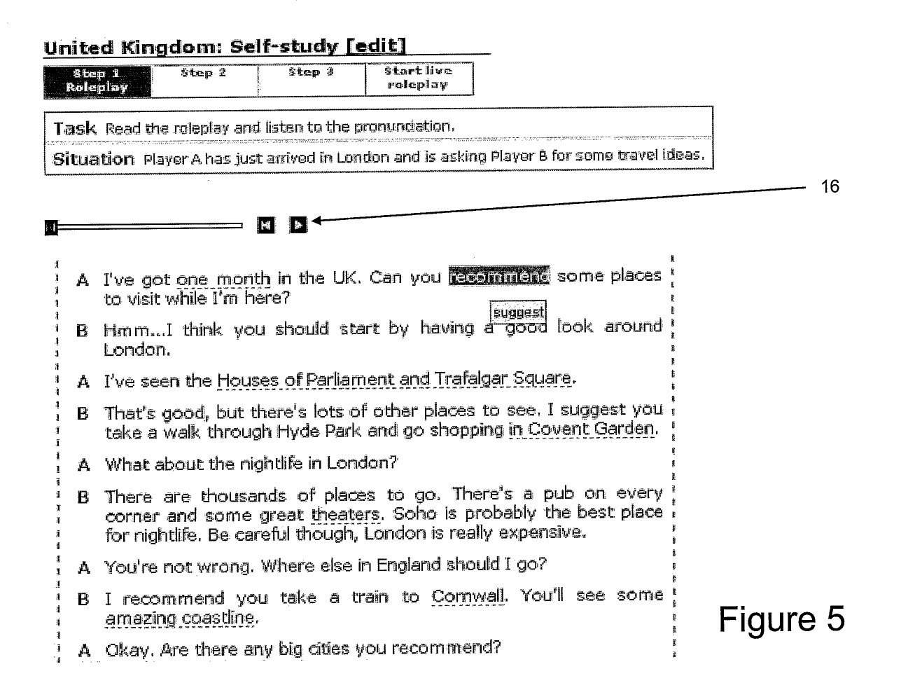

This will then take the user to another page (FIG. 5) displaying the first step of the role-play in which the user can read text of a two-person dialogue displayed on the screen. The user can also hear the dialogue by clicking on a link 16 provided. The user can also use so-called ‘mouse over’ help, in which the user scrolls over the dialogue text using his mouse and a help message is presented in text on the screen. The use of this ‘mouse over’ feature is a well known feature in applications and need not be described in any further detail herein.

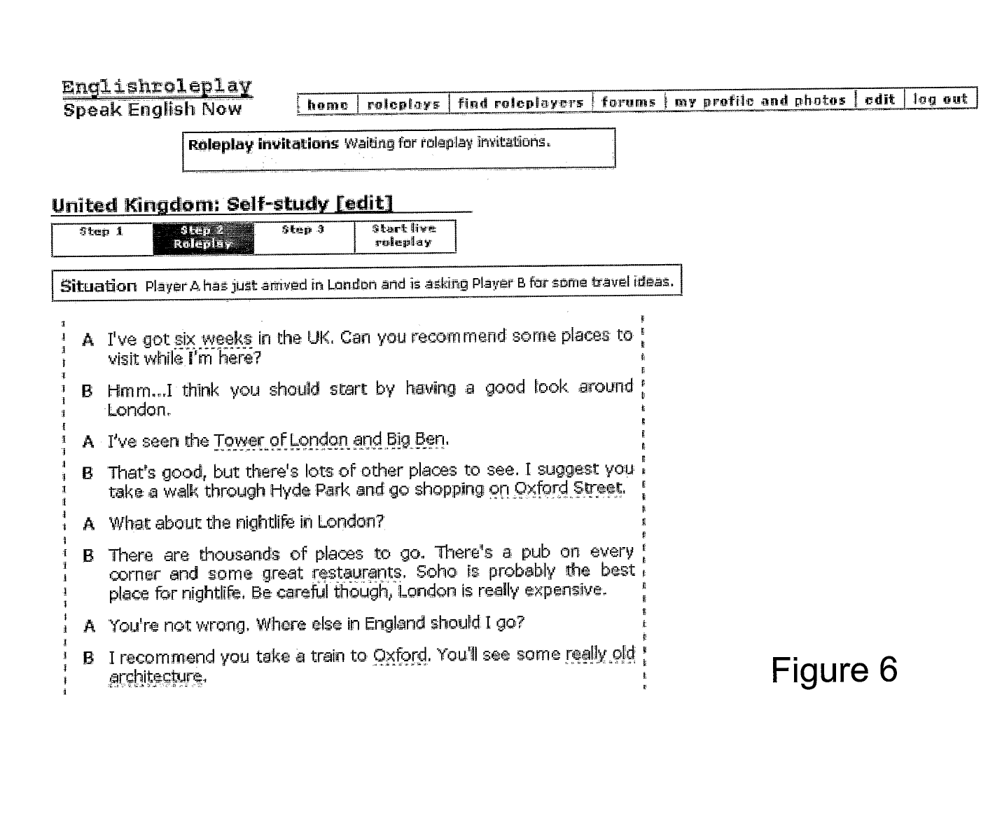

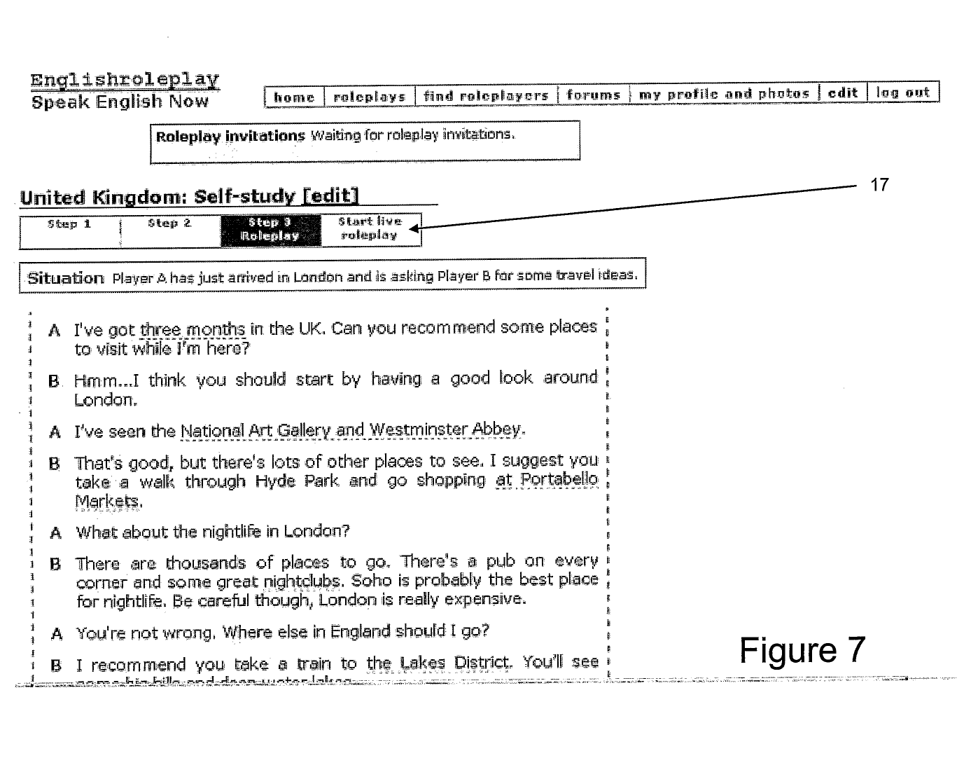

As the user is studying the role-play, the amount of time that the user has been studying that step of the role-play (in seconds) is stored at the server 11. In this embodiment, the role-play comprises three steps—each step being displayed on a separate web page (see FIGS. 6 and 7). The user can stop at any point, go back and repeat steps to practice their pronunciation.

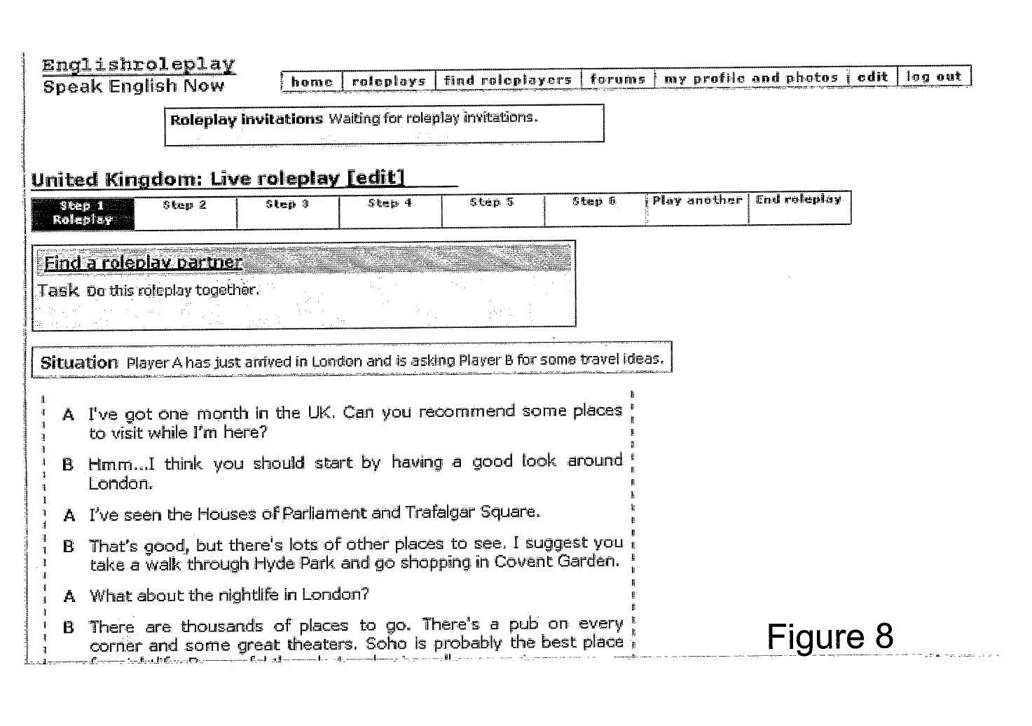

When the user feels confident about doing the role-play in a ‘live’ environment, then he clicks on a link 17 which takes him to a ‘Live Roleplay’ page 18—see FIG. 8. In this embodiment, the user cannot proceed to the ‘live’ environment until they have studied each page for at least 20 seconds.

A live role-play consists of a real-time dialogue between two users in voice communication, each user being assigned a role in the role-play that they have studied, and speaking their role, while reading the script as it is displayed on the page.

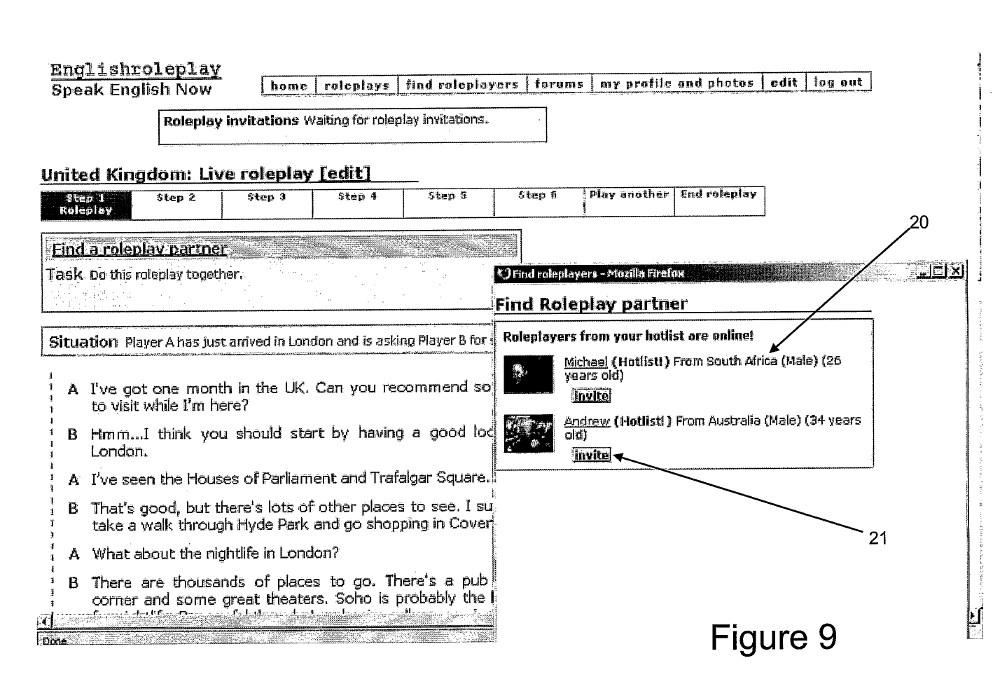

The first thing that the user needs to do is to find another person with which to carry out the role-play. To do this, the user clicks on the ‘Find a roleplay partner’ bar 19, as illustrated in FIG. 8. The system then displays a drop down list 20 (see FIG. 9), which details other subscribers to the website who are currently online, and who have also studied this role-play. Any potential partners that have partnered the user previously are listed at the top.

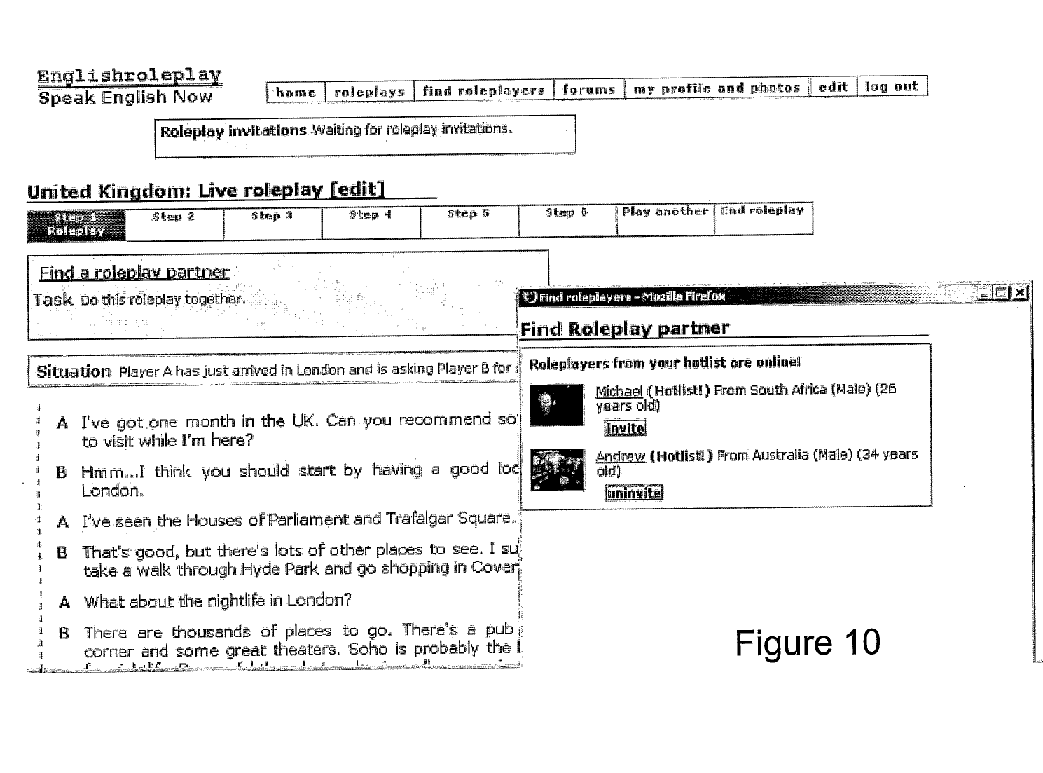

The user (‘inviter’) can then choose to invite any of the people in the drop down list by clicking on the ‘invite’ button 21. If the inviter invites one of the people on the list, the current page is refreshed to present the user with the option to uninvite the selected person—see FIG. 10. A signal is sent from the inviter's computer to the server 11. The server 11 is operable, in response to this signal, to send out the invitation to the selected person. After the invitation is sent out, the inviter's computer regularly polls the server 11 to detect any acceptances.

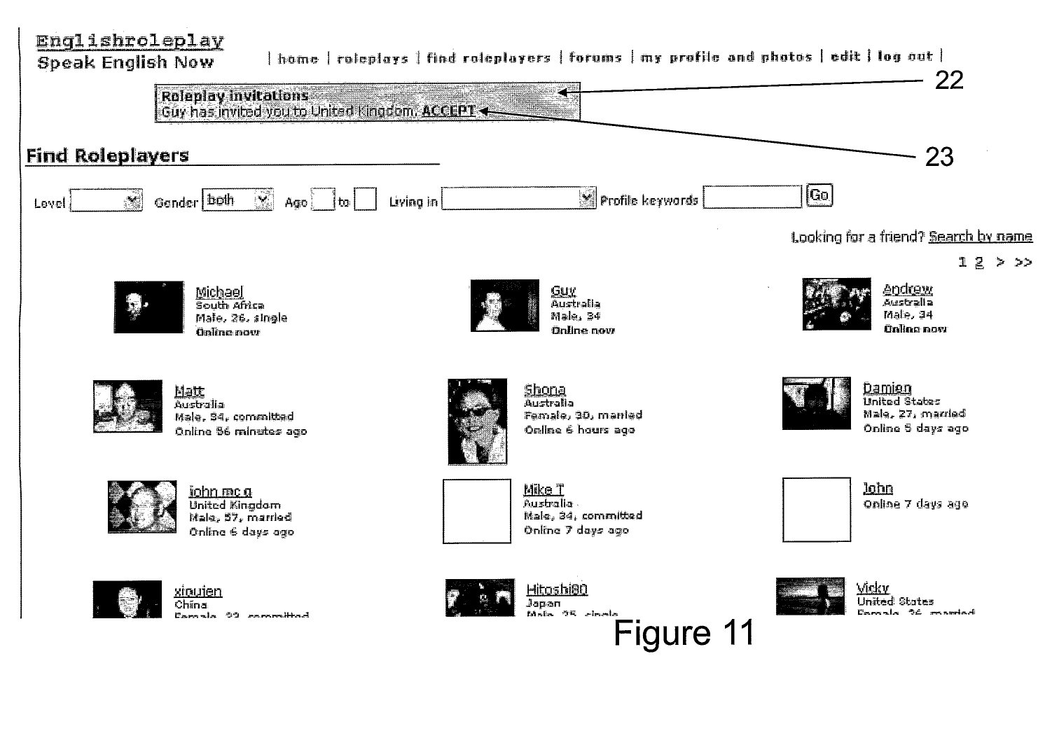

The invitation is displayed to the potential partner via a notice board 22 displayed on all web pages. The notice board 22 is updated every few seconds with any new notices. Notices include invitations to join a live role-play. This is illustrated in FIG. 11. When users are online, their computers are regularly polling the server 11 to detect invitations. Any invitations are then detected and displayed on the noticeboard 22.

The invited user (‘the invitee’) can accept the invitation, by clicking on an ‘accept’ button 23.

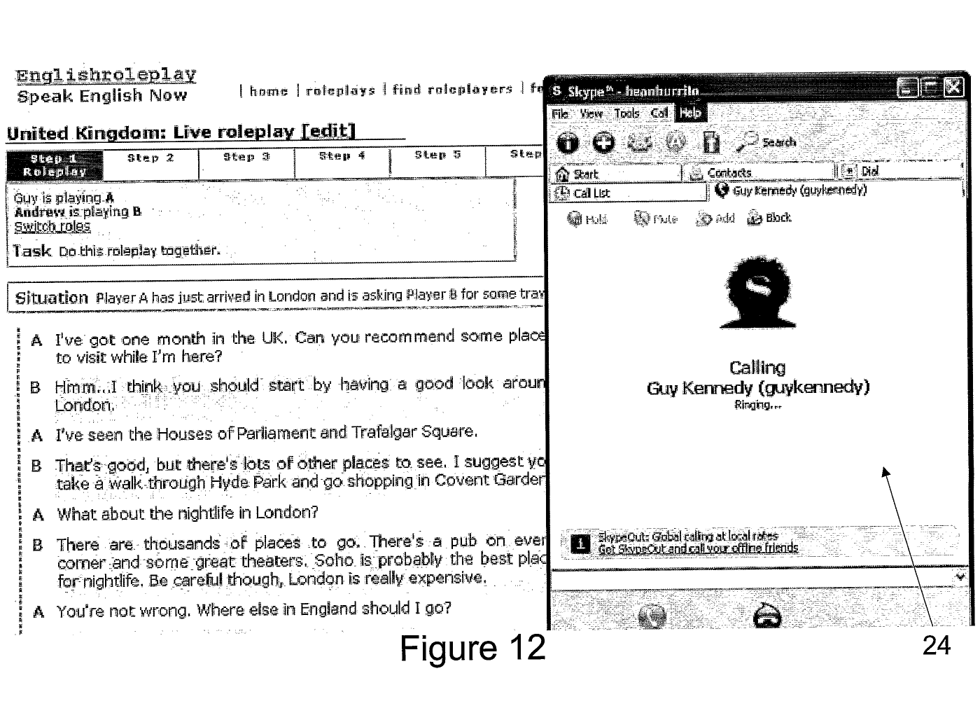

Upon accepting the invitation, the invitee is taken to Step 1 of the ‘live’ environment of the selected role-play. At the same time the invitee's Skype application calls the inviter's Skype application. The Skype window 24 is displayed on the invitee's screen—calling the inviter—as shown in FIG. 12.

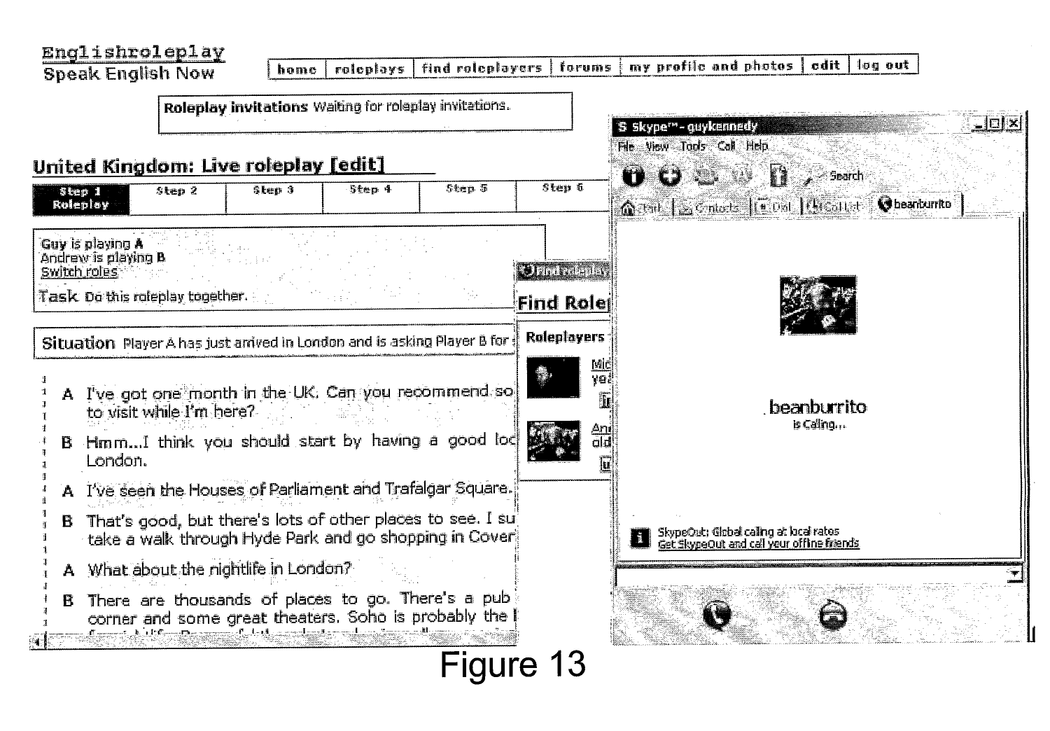

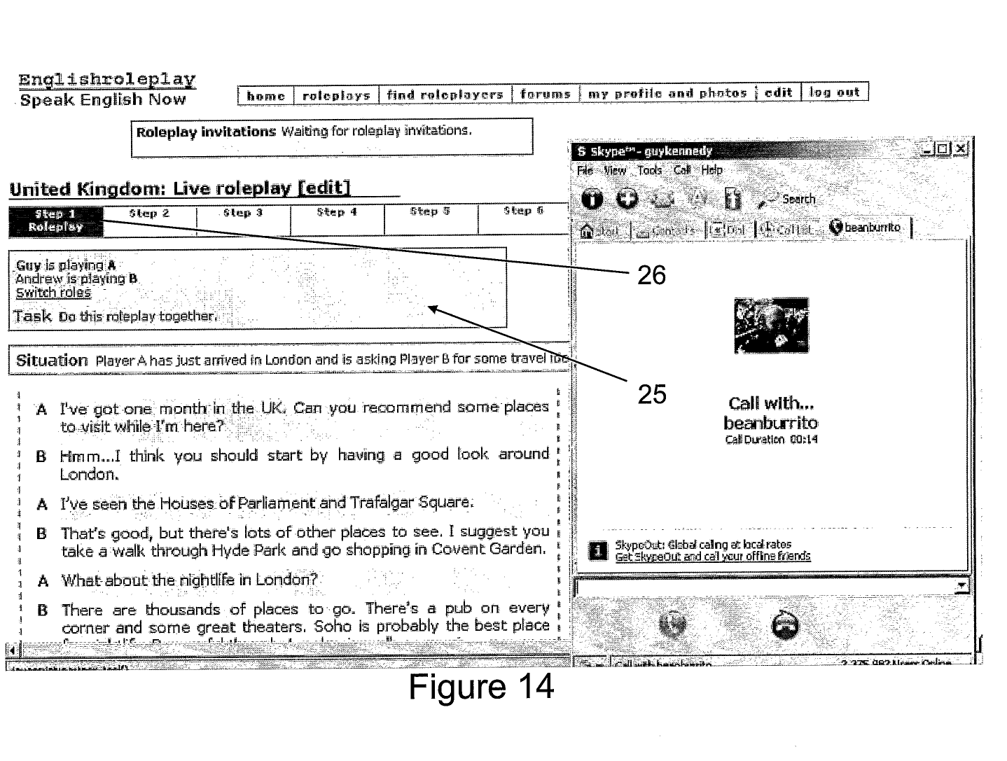

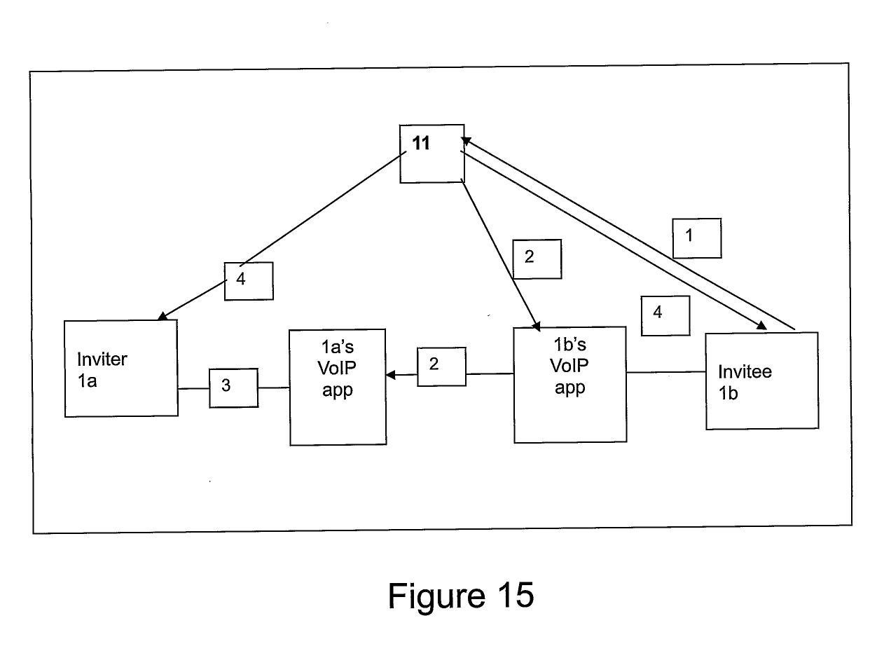

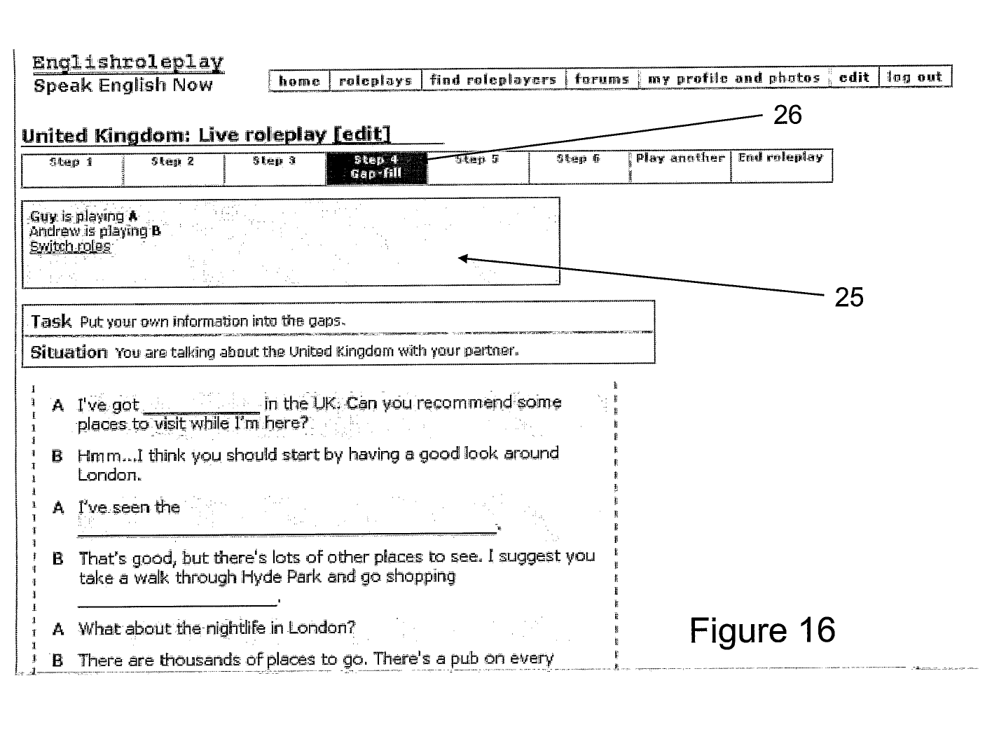

When the server 11 receives data from the inviter's computer 1a indicating the invitation, the server 11 sends the invitation to the invitee's notice board as shown in FIG. 11. The invitee can accept the invitation by clicking the accept button 23. If the invitee accepts the invitation as shown in Step 1 of FIG. 15, the invitee's Skype application calls the inviter's Skype application as shown in Step 2 of FIG. 15 (NB. FIG. 12 shows the invitee's screen as his Skype application calls the inviter). This is possible as both Skype usernames are embedded in the server 11. The server 11 instructs the invitee's Skype application to call the inviter's Skype application by using the code “callto:inviterskypeid”. This code is commonly used by the Skype community for website integration. The inviter can accept or reject the incoming Skype call, or do nothing, as shown in Step 3 of FIG. 15 (NB. FIG. 13 shows the inviter's screen, as the incoming Skype call arrives). If the inviter accepts the invitee's Skype call, the users are in audio communication (NB. FIG. 14 shows the inviter's screen just after he has accepted the incoming voice call by clicking the ‘green phone’ button on the Skype application). At the same time as the server 11 instructs the invitee's Skype application to call the inviter's Skype application, the server 11 directs both clients into the shared Live Environment, as shown in Step 4 of FIG. 15 (NB. FIG. 12 shows the invitee's screen as he is simultaneously directed to the Live Environment and his Skype application calls the inviter). This is discussed further below.

At this stage the server 11 is also operable to allocate roles to the inviter and invitee, and data indicating this is sent to each user and displayed. This is illustrated, for example in FIG. 14, where the allocated roles are displayed in a frame 25. Each user's name and role are presented individually in colour, e.g. frame 25 shows the inviter's name and role in red font.

The inviter sees and hears the incoming Skype call from the invitee—see FIG. 13. The inviter answers the call and so the inviter and invitee are in audio communication—see FIG. 14, and are both seeing Step 1 of the role-play.

The steps referred to above are illustrated schematically in FIG. 15, as indicated below.

| Step | Action |
|---|---|
| 1 = | Invitee 1b accepts inviter's 1a Invitation; |
| 2 = | Server 11 instructs invitee's 1b VoIP application |
| | to call inviter's 1a VoIP application; |
| 3 = | Inviter can accept or reject invitee's VoIP call; |
| 4 = | Server 11 directs both clients into the shared Live Environment. |

The inviter and invitee are then able to run through the role-play, each speaking their allocated role. Their allocated role will be highlighted to help them identify which lines they are to speak.

When they have finished this, then the invitee and inviter can move on to the next step. Each successive step is chosen by clicking on the relevant button 26 on the web page.

The first three steps of the role-play are exactly the same as those practiced before. The role-play is then repeated, but with incidental information removed, and the inviter and invitee have to insert their own ideas. This is illustrated in FIG. 16.

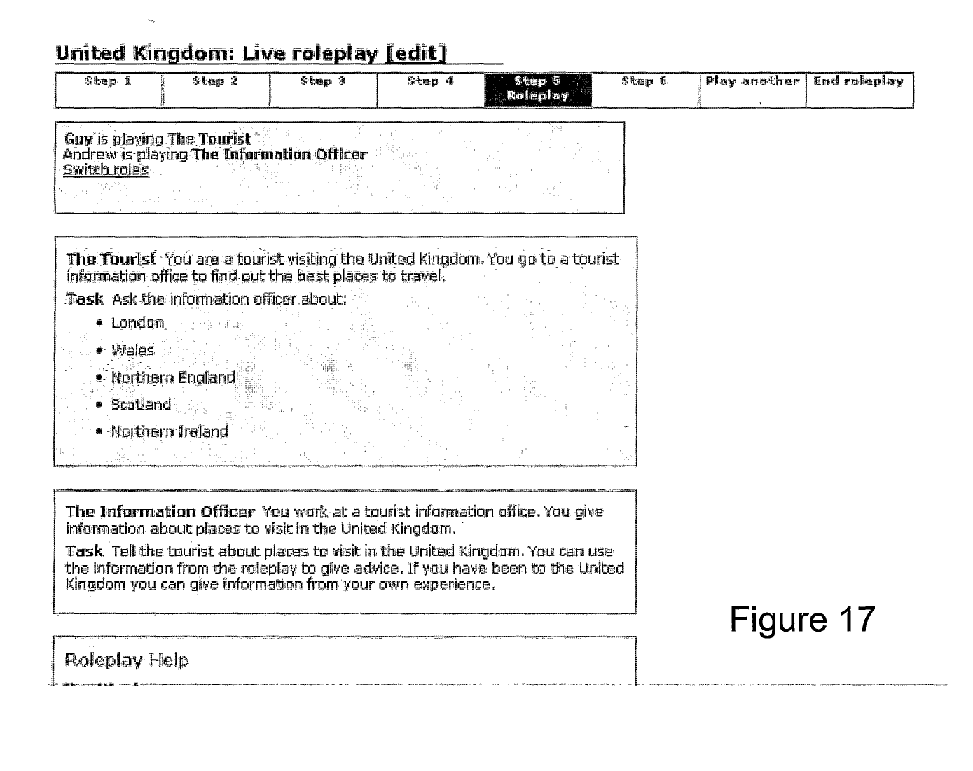

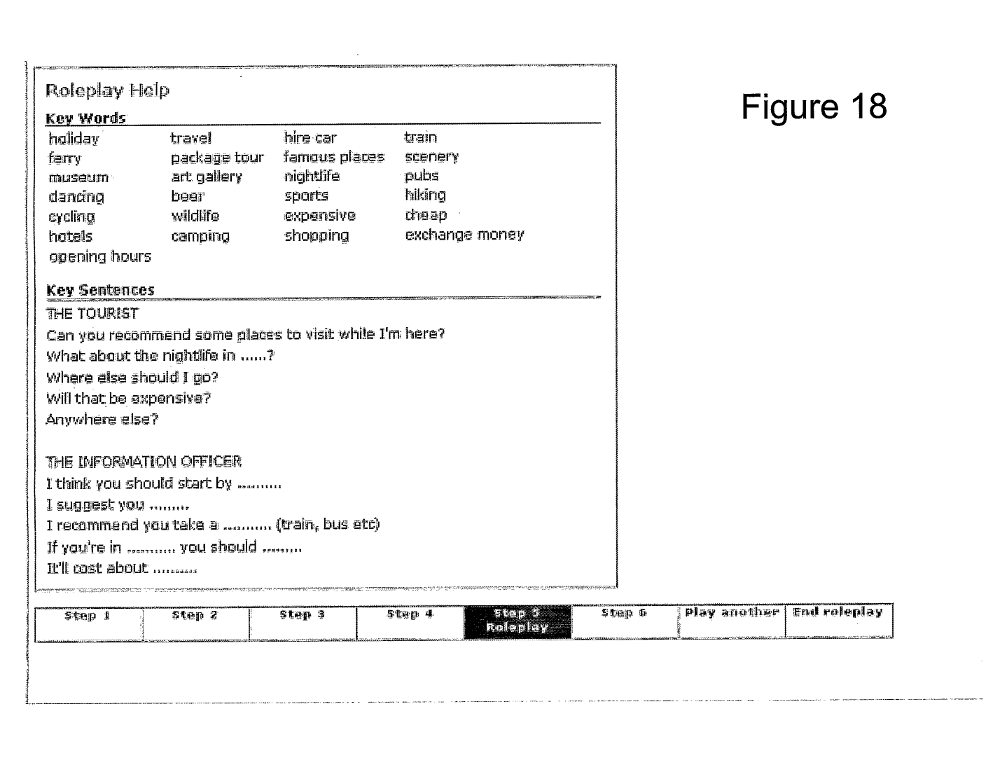

When they have finished this part, then the inviter and invitee are presented with a situation, allocated roles and information and presented with a task which draws on the language that they have practiced earlier. This is illustrated in FIG. 17. If either user requires any help such as key words and sentences, then they can access a ‘Help’ section which is displayed by scrolling down the web page—see FIG. 18.

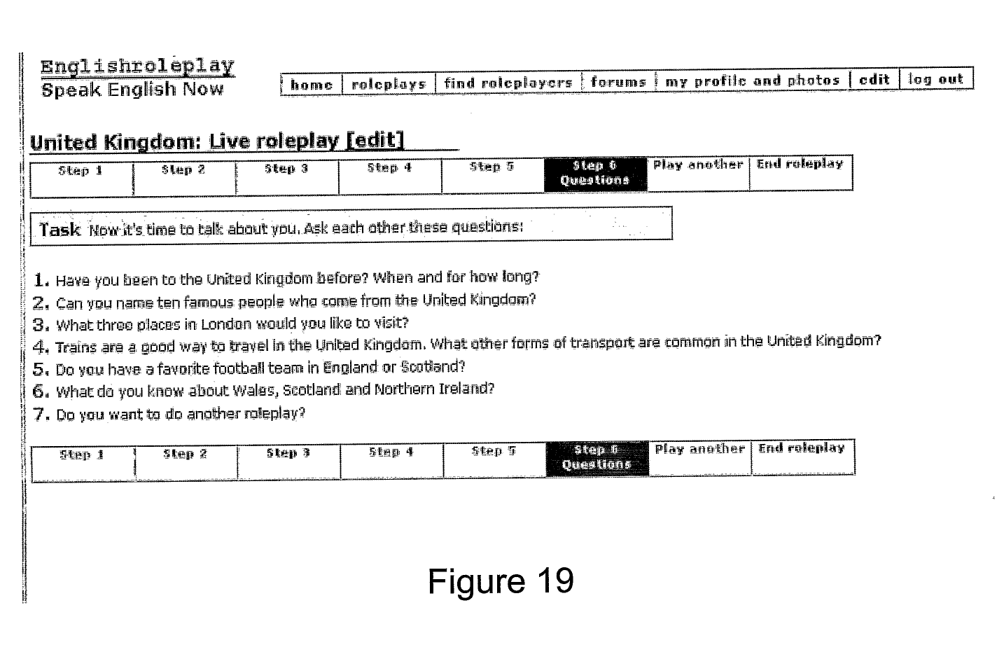

A final part of each role-play is where each user is presented with questions about their real lives, giving them a chance to personalize what they have learned—see FIG. 19.

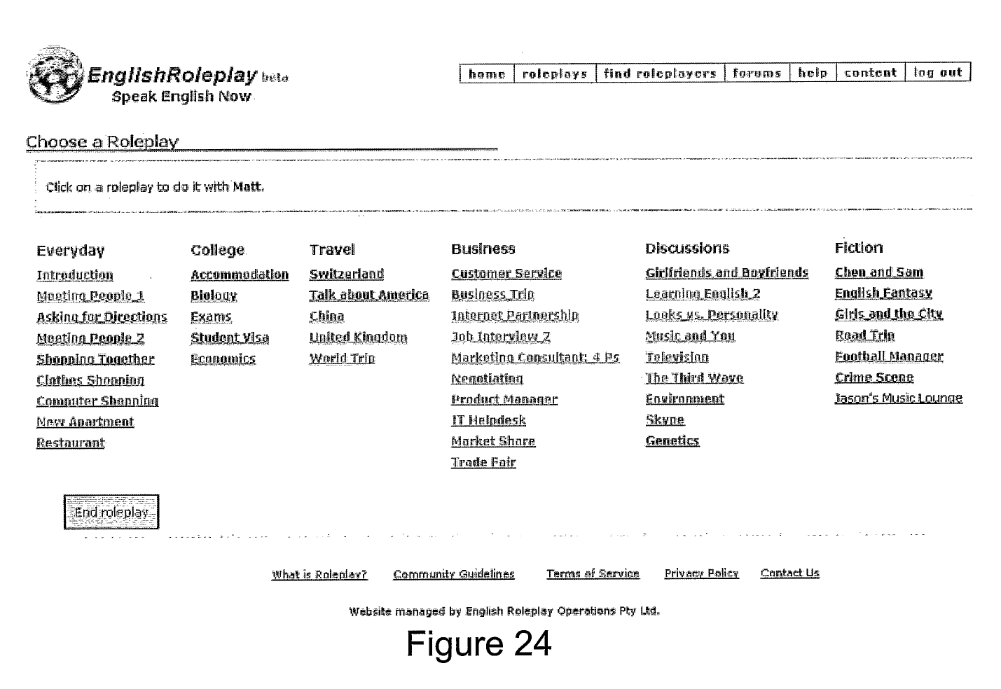

When they have completed all the steps, the two can decide to do another role-play by clicking the “Play another” button—see FIG. 19—and they are both presented with a page which displays commonly studied role-plays—see FIG. 24. They can then decide to continue with a new role-play or end the role-play. If they decide to continue then they are presented with a web page showing the start of a new role-play and the server 11 will have allocated them both their respective roles. Bearing in mind that they are both in audio communication they can also discuss other options, for example, that one of them should study a certain role-play that they haven't previously, but the other had.

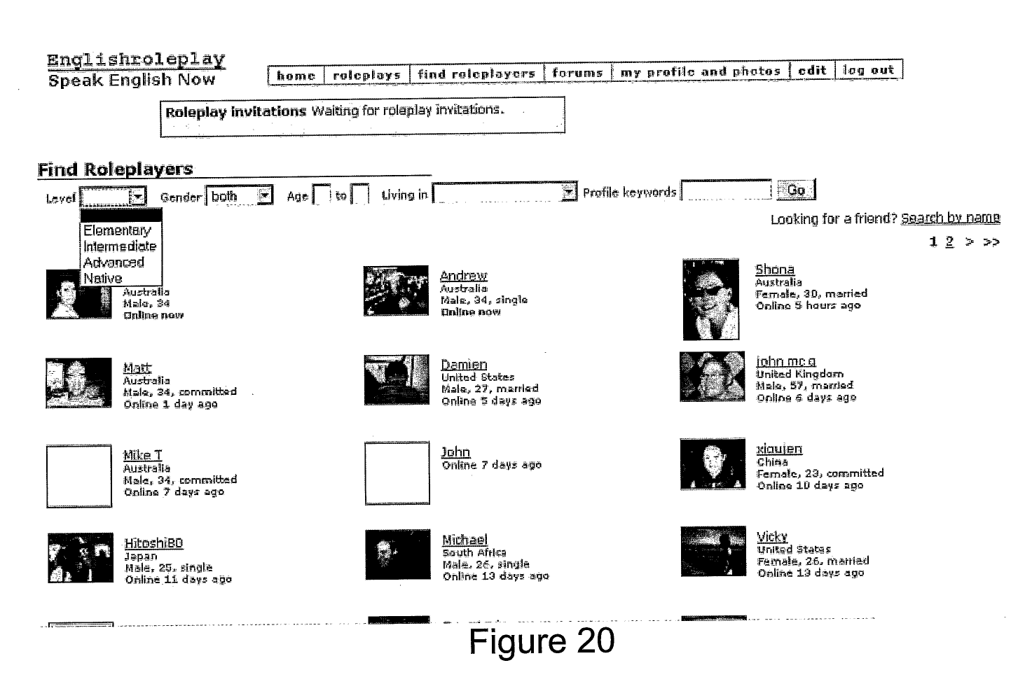

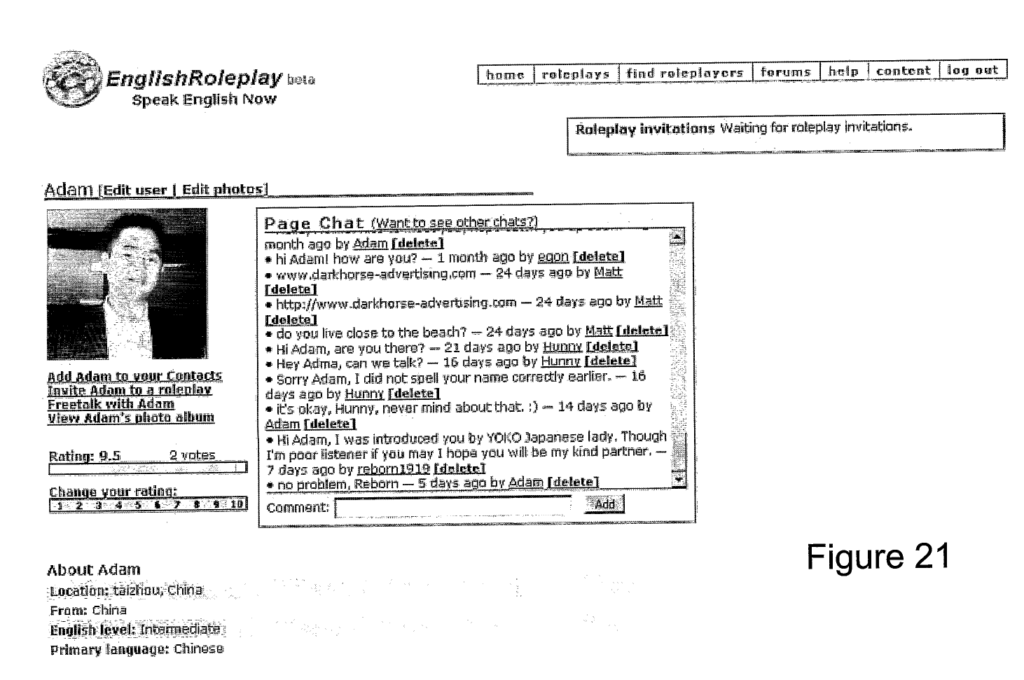

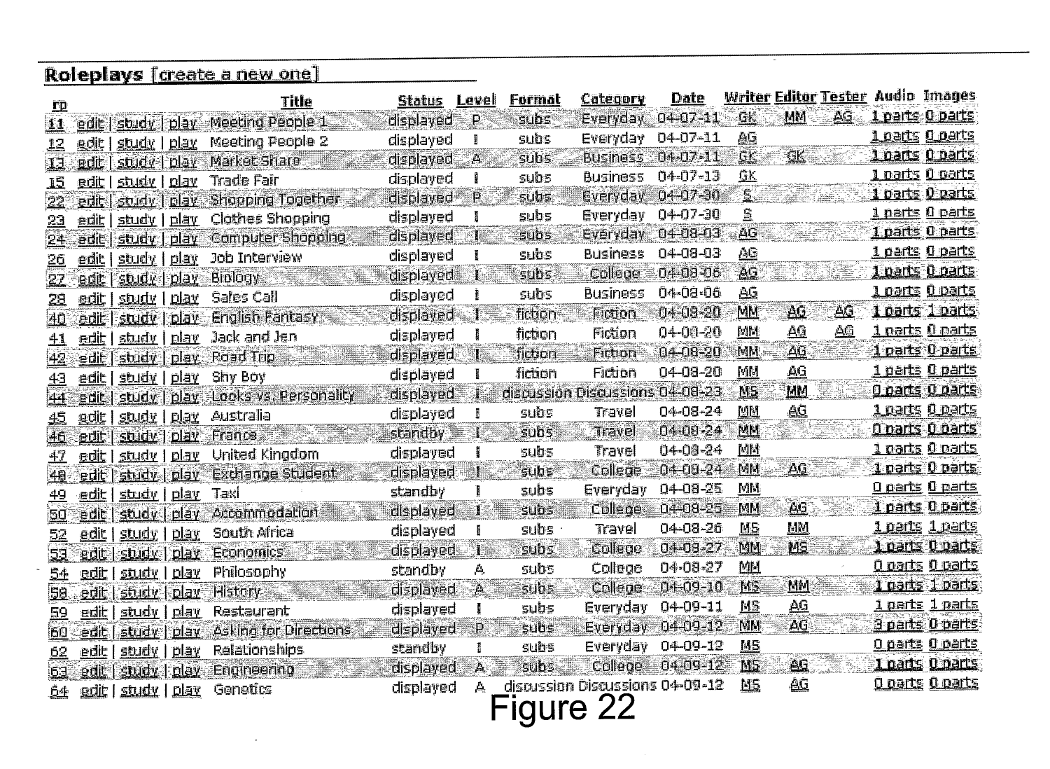

It is also possible to search for role-players to engage with by using a search facility. A user can search by such criteria as language ability, studied roleplay, age, gender, where they live and so on. This is illustrated in FIG. 20. Details of potential role-players are also available—see FIG. 21.

Users can invite other users from this “profile page” shown in FIG. 21. The inviter clicks “Invite (roleplayer name) to a roleplay” and is shown a list of roleplays studied by both inviter and invitee, as shown in FIG. 24. The inviter then clicks a roleplay title and an invitation is sent to the invitee, inviting him to carry out that roleplay with the inviter.

In another embodiment of the invention, a discussion format can be used to allow users to study a topic then have a discussion about the issues within that topic.

This format is also a nine-part format whereby users study and discuss differing points of view on three related issues within a topic and discuss the issues by answering a series of questions, and giving their opinions. The process is as follows:

In the first part, a user studies warm-up questions and thinks about how to answer them with a partner.

In parts 2 to 4, the user studies three issues within a certain topic. The information is presented as the opinions of two different third person characters.

In part 5, when the user feels confident about discussing the issues live, he proceeds to select a discussion partner in the same way as described above. They are linked using VoIP and they ask each other the warm-up questions.

In parts 6 to 8, the users are prompted to discuss the opinions of the characters together. In part 9, the two users are presented with information and then asked to give their opinions on this information.

In a further embodiment, users can study scripts with audio language modelling, and then assume roles to engage in a story and interactively create their own ending. This is also a nine-part process, which is as follows:

In parts 1 to 3, the user studies three short scripted ‘chapters’ of a story. They study a text, listen to the audio version, and use the ‘mouse-over’ vocabulary help.

In parts 4 to 6, and again when the user feels confident about doing the role-play live, they can access a web page that lists other waiting users who have studied the same role-play, and select and invite a partner in the manner described above. They are then linked using VoIP and are allocated roles. They role-play the three studied scripts together.

In part 7 the users are then presented with a new development in the story. They must discuss four options for what they (as characters) should do next and select one.

In part 8 the users are told whether their choice was correct or not. They are then given a few lead-in lines for the next chapter, and must create the next part of the story together in character.

In part 9 they are presented with questions about the story and about their real lives. They ask and answer the questions together.

As well as users being ‘students’ wishing to learn and practice a language, users can be ‘teachers’ who are able to help other users. Such teachers will provide this service for suitable remuneration. The server provides means in the form of appropriate database functions to record the time a teacher is engaged with a first user. In a particular adaptation, the server will provide means to collect appropriate payment from a particular first user for time engaged with a teacher and means to disburse this payment to the respective teacher.

In a further embodiment of the invention, a user's homepage can be tailored to represent a ‘classroom’. Users can add other users to their homepage (‘classroom’) by clicking the ‘add to hotlist’ button on each user's profile page. From a user's homepage, they can invite their ‘hot-listed’ users' by clicking the ‘invite’ button under each hot-listed user's photo. After an inviter clicks ‘invite’ they are shown a list of commonly studied role-plays. The inviter is then prompted to click a role-play title upon which an invitation is sent to the invitee using the same method described above. A user's ‘classroom’ page can be used to list teachers and students, and provide streamlined connection paths between regular language partners and teachers.

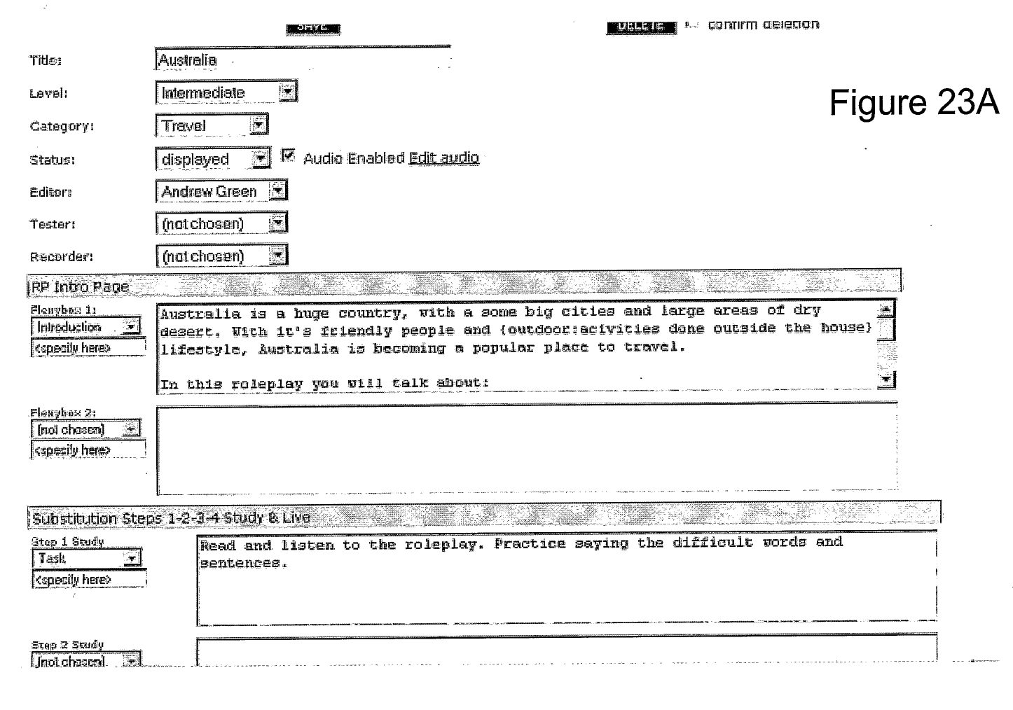

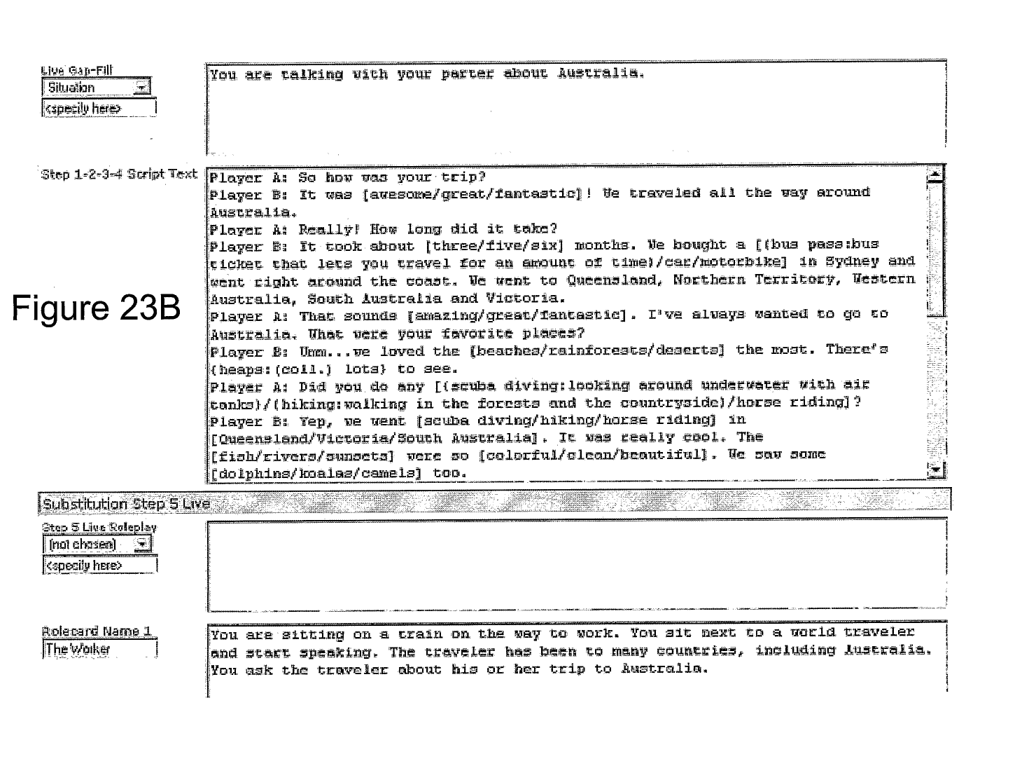

In addition to the web pages accessible by people wishing to engage in role-plays, web pages accessible by people with special privileges provides for administration of the system, for example to monitor what role-plays are available (FIG. 22), to add new role-plays and to edit existing role-plays (FIGS. 23a, 23b).

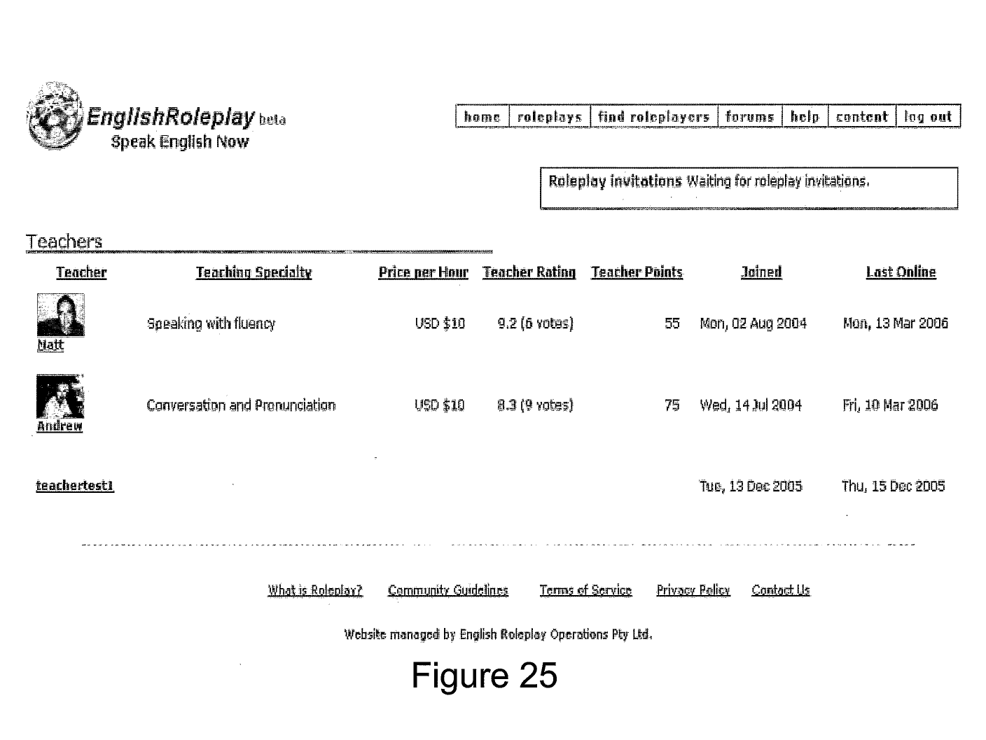

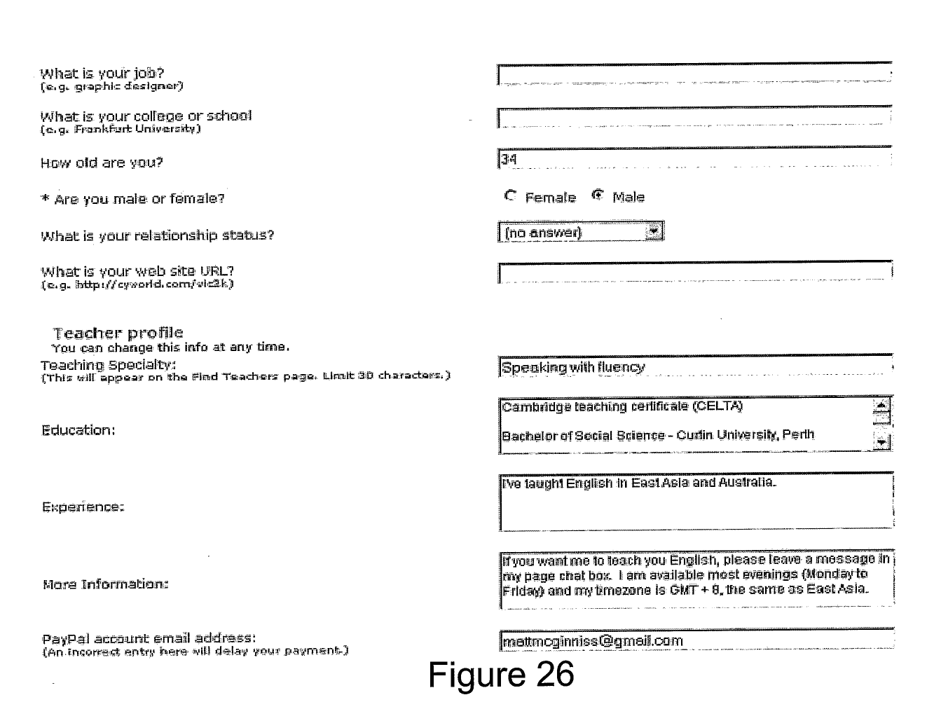

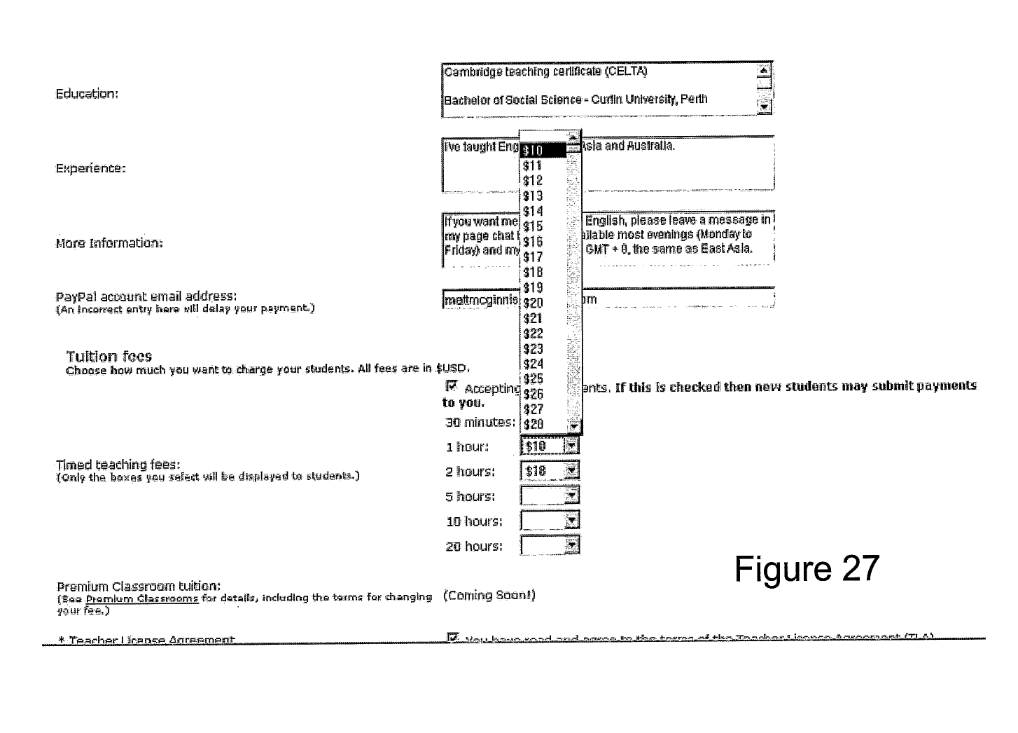

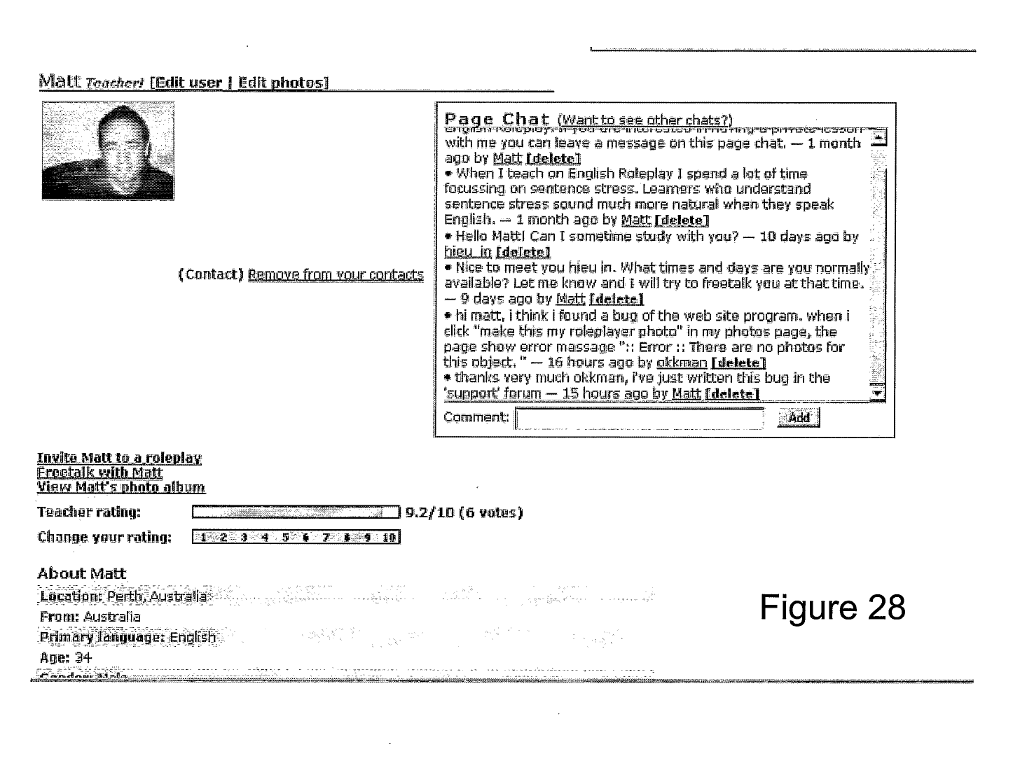

In a further embodiment of the invention, users can search for a language teacher based on criteria such as name and photo, teaching specialty, price per hour, teacher rating, teacher points, date joined and date last online. Users can click on the headings to sort teachers based on the chosen criteria. The Teachers page is illustrated in FIG. 25. The “Teaching Specialty” input page is shown in FIG. 26. Teachers can set their own tuition fees as shown in FIG. 27. “Teacher Rating” is the average rating out of ten of the teacher given by the users. Each user can rate a teacher only once but can change the rating at any time. A Teacher's rating is updated instantly after a user changes their rating or makes a new rating of a Teacher. This is illustrated in FIG. 28. “Teacher Points” is the total ratings of a teacher, out of ten, made by all members of the community.

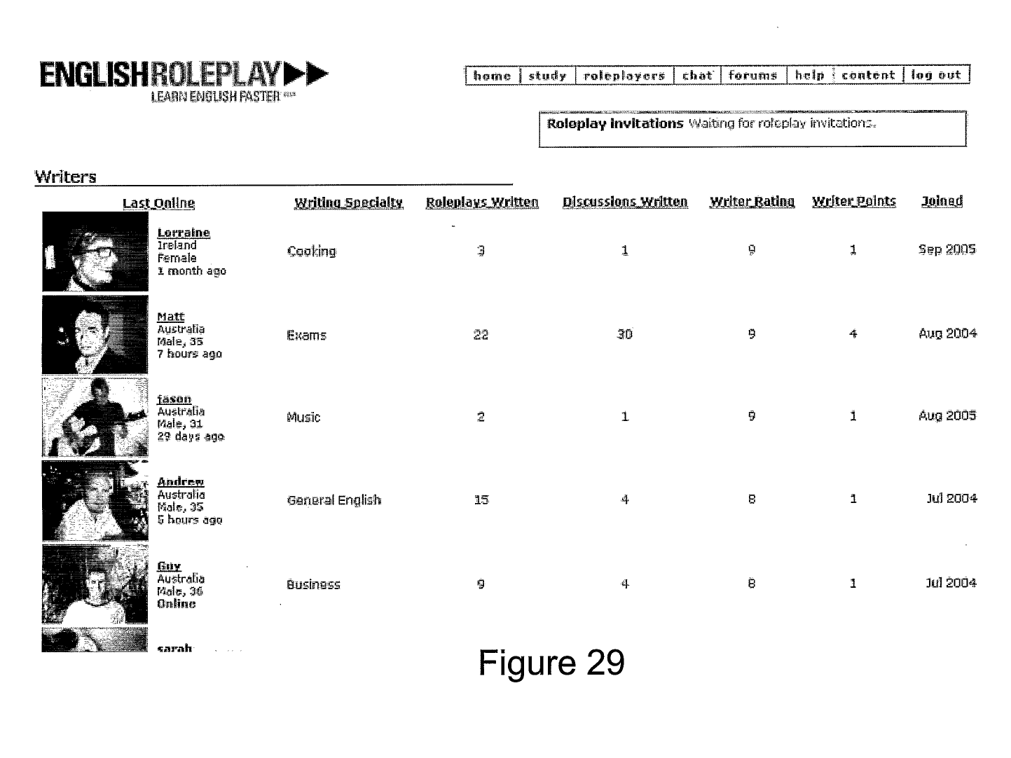

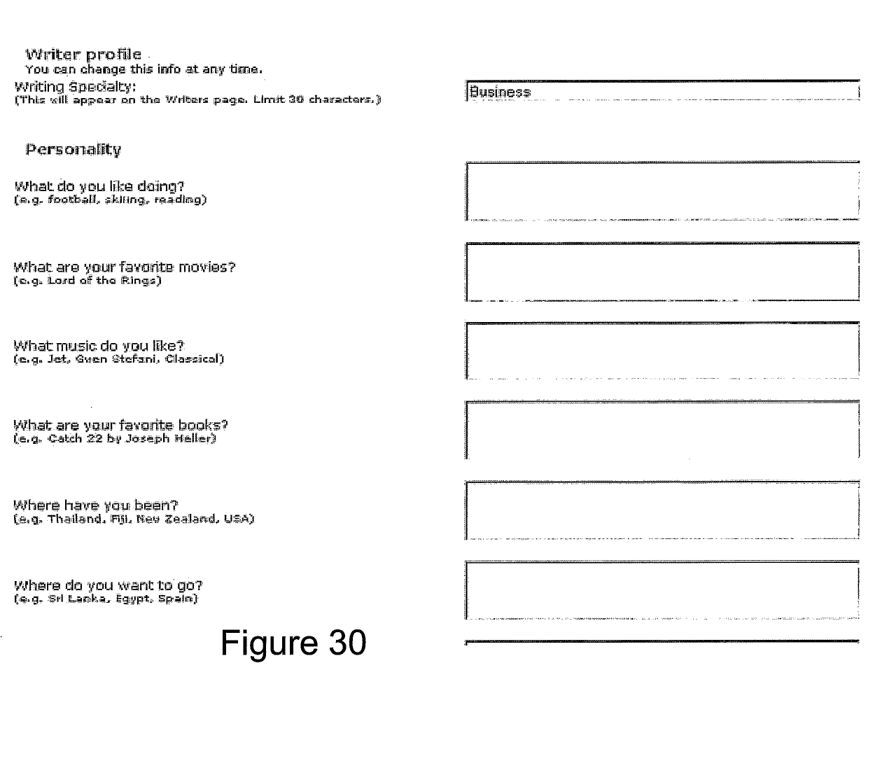

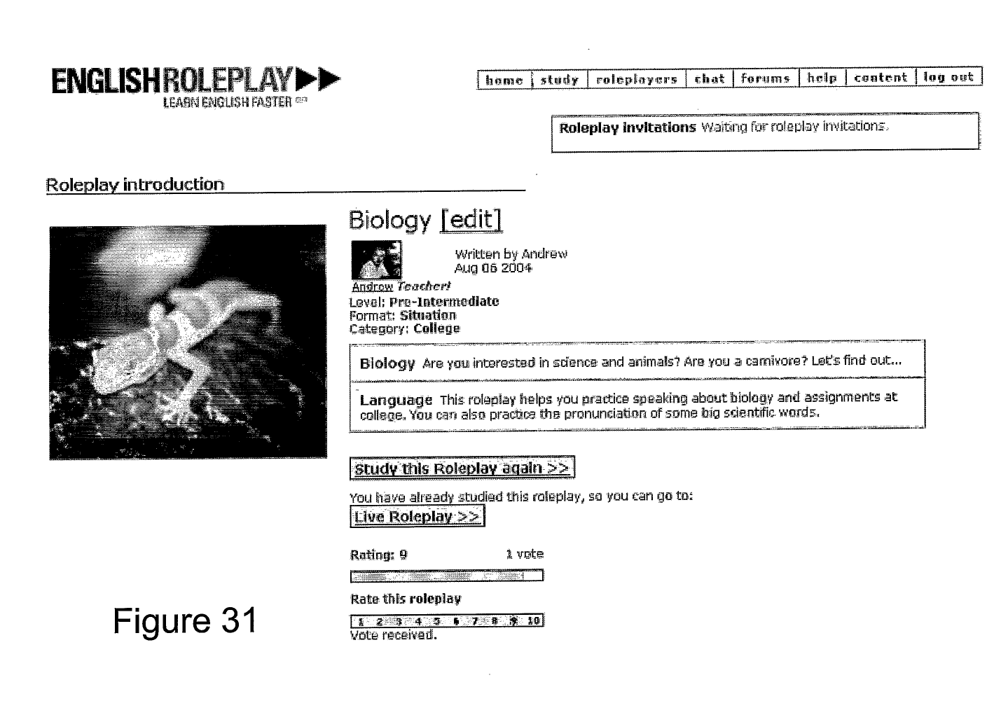

In a further embodiment of the invention, users can search for a writer of role-play or discussion content, based on criteria such as date last online, writing specialty, role-plays written, discussions written, writer rating, writer points and month joined. Users can click on the headings to sort writers based on the chosen criteria. The Writers page is illustrated in FIG. 29. The “Writing Specialty” input field is shown in FIG. 30. “Roleplays Written” is the number of role-plays published on the website by a writer. “Discussions Written” is the number of discussions published on the website by a writer. “Writer Rating” is the average rating out of ten, given by the users, of the role-plays and discussions published by a writer. Each user can rate a role-play or discussion only once but can change the rating at any time. The role-play or discussion rating feature is shown in FIG. 31. A writer's rating is updated instantly after a user changes the rating or makes a new rating of that writer's role-play or discussion. “Writer Points” is the number of ratings made by users of a writer's role-plays or discussions. “Joined” is the month that the writer signed up to the website as a user.

In a further embodiment of the invention, any user who is logged in can make a rating out of ten of any other user. Each user's average rating received is displayed on the user's “profile page”, as shown in FIG. 21. As with the “Teacher Rating” method described above, each user can rate another user only once but can change the rating at any time, as also shown in FIG. 21. A user's rating is updated instantly after a user changes their rating or makes a new rating of another user.

As mentioned above, the system 10 includes a server 11 upon which the web pages of the website are stored. The server runs the appropriate applications and stores data in suitable databases in any suitable, known, manner. In the embodiment referred to herein, the web pages can be programmed for example using applications such as JavaScript and Flash—both well known proprietary applications—while the website may be served by a system such as mod_perl Apache™ running on the Linux™ operating system.

Images and audio can be stored as files, and other data is stored in a structured query language relational database such as MySQL™.

Role-plays are contained in several tables—a general table, one containing the line-by-line scripts, another for the cue cards used in some role-play formats discussed above, and one for open-ended questions. Although stored across these different tables, the material for each role-play is consolidated on a single page for ease of editing. Other tables in the database store user information such as identification details and so on.

In order that users of the system are alerted to invitations without any significant delay, the system polls a service every few seconds to check for status changes. In the embodiments, this is implemented using Burstlib JavaScript within the web pages accessing one of the mod_perl handlers on the server 11. This communication over HTTP works in the background. The polling is used for the following:
For updating of the noticeboard. For example, with invitations to engage in live role-play, or if someone from a user's classroom comes online. The noticeboard is a feature that is present on all web-pages and is dynamic—notices only appear for a few seconds.
For tracking the status of a user. This is bundled in the same HTTP requests used for the noticeboard. This updates the database to mark the user as being online. The information is also used to indicate, for example, when a user was last online, and whether a user is an eligible recipient for invitations.
For tracking ‘study habits’ of a user. This determines how long a role-play has been studied. In the ‘embodiment’ described herein, a role-play is considered to have been studied once the user spends at least 20 seconds on each step of the study pages. Monitoring of this aspect is necessary in order to determine whether the user has studied the role-play for the required period of time as discussed above.
In the process of inviting, accepting invitations, and allocating roles. This is used within the live role-play pages. Once an invitation has been issued, the inviter's computer 1a polls the server 11 regularly to detect if the invitation has been accepted. If an invitation is accepted before it expires, and if a competing invitation is not accepted first, then the server 11 allocates the roles (as mentioned above). The inviter and invitee are presented with the live role-play pages, each customized for the particular role. As they move through the role-play steps, this polling provides that their roles and locations are synchronised.

It will be evident to persons skilled in the art that variations may be possible within the scope of the present invention. Other applications can be used to provide the operability of the website, and any other suitable VoIP application, or other method of audio communication, may be used. The web pages themselves can be adapted to suit the requirements of the members and the languages being used. Other language learning models can be adapted to be delivered using the integrated web-based, peer-to-peer, and VoIP approach discussed in this specification. Features such as the length of study time required for live role-play may also be varied.

What is claimed is:

1. A language learning system adapted to facilitate the learning of a language by at least a first of two separated people over a communication means adapted to provide two-way communication between the two people, being a first user and a second user, the system comprising means for presenting a scripted dialogue as displayed text to said first user, and means for presenting the same scripted dialogue as displayed text to a said second user, wherein the communication means enables voice communication between the first and second user simultaneously with the presenting of the scripted dialogue.

2. A language learning system as claimed in claim 1, wherein the means for presenting the scripted dialogue as displayed text uses the Internet to present the scripted dialogue as web pages, and the means for enabling voice communication uses a Voice over Internet Protocol application.

3. A language learning system as claimed in claim 2, wherein the system is operable to present the scripted dialogue first to the first user prior to enabling voice communication, and is also operable to: receive a first signal from the first user indicating a wish to communicate with the second user, to send a second signal to the second user in response to the first signal indicating the wish to communicate, and to receive a third signal from the second user indicating an acceptance of the wish to communicate, the system being further operable, in response to the third signal, to present the scripted dialogue to the second user, and to launch the Voice over Internet Protocol application.

4. A language learning system as claimed in claim 3, wherein the Voice over Internet Protocol application specifies that the second user calls the first user upon acceptance of the wish to communicate.

5. A language learning system as claimed in claim 2, wherein the system is operable to allocate specific roles in the scripted dialogue to the first and second users, the scripted dialogue being presented to the first and second users with indications of their roles.

6. A language learning system as claimed in claim 2, wherein the system is operable to present variations of the scripted dialogue after first presenting the scripted dialogue as a whole.

7. A language learning system as claimed in claim 6, wherein the variations comprise removing portions of text from the scripted dialogue.

8. A language learning system as claimed in claim 2, wherein the system further comprises a server adapted to cause respective web pages to be displayed before the first user and the second user at required moments in time.

9. A language learning system as claimed in claim 8, wherein the server comprises means to control access to the language learning system by the users.

10. A language learning system as claimed in claim 9, wherein the server comprises means to monitor and control the interaction of the first and second users with the language learning system and with each other.

11. A language learning system as claimed in claim 10, wherein relevant data about a user is recorded within a database associated with the server and may be viewed on a web page by other users.

12. A language learning system as claimed in claim 1, wherein means is provided for a user to provide an indication of the performance of another user with whom he has engaged in a scripted dialogue comprising a role-play and for the indications for a particular user to be averaged to provide a performance rating for said particular user.

13. A language learning system as claimed in claim 8, wherein the second user is a teacher who provides time in tutoring the first user as a service for remuneration and wherein the server comprises means to record the time spent by the teacher in tutoring the first user.

14. A language learning system as claimed in claim 13, wherein the system comprises means to collect payment from the respective first user for time engaged with the teacher and means to disburse payment to said teacher for time spent in tutoring said respective first user.

15. A language learning system as claimed in claim 12, wherein the first user and the second user are students and a third user is a teacher who provides time in tutoring said first user and said second user as a service for remuneration and wherein the server provides means to record the time spent by the teacher in tutoring the first user and the second user.

16. A language learning system as claimed in claim 15, wherein the system comprises means to collect payment from the respective first user and second user for time engaged with the teacher and means to disburse payment to the teacher for time spent in tutoring said first and second users.

17. A language learning system as claimed in claim 13, wherein a user is able to search for a suitable teacher from a list of teachers who each have their average rating displayed on the same page.

18. A language learning system as claimed in claim 1, wherein a user is able to provide an indication of the learning benefits of a scripted dialogue comprising a roleplay or discussion written by a particular writer and for the indications for the particular writer to be averaged to provide a performance rating for said writer.

19. A language learning system as claimed in claim 18, wherein a user is able to search for a suitable writer from a list of writers who each have their average rating displayed on the same page.

20. A language learning system adapted to facilitate the learning of a language by at least a first of two separated users, being a first user and a second user, comprising a web-based system which integrates peer-to-peer communications with Voice over Internet Protocol technology to provide one-to-one communication which enables said users to speak in real-time with the intention of taking part in scripted role-play scenarios in the language to be learned which enables the first user to practice skills in this language wherein the text of a selected role-play is displayed before each of said users simultaneously with the said speaking in real-time.

21. A method for learning language in which a scripted dialogue is presented as displayed text to a first user and a second user, whilst enabling voice communication between the two users simultaneously.

22. A method for learning language as claimed in claim 21, wherein the scripted dialogue is presented using web pages over the Internet, whilst the voice communication is enabled using a Voice over Internet Protocol application.

23. A method for learning language as claimed in claim 22, wherein the scripted dialogue is first presented to the first user, and is only presented to the second user after the first user has issued an invitation to the second user, and that invitation has been accepted by the second user.

24. A method for learning language as claimed in claim 23, wherein upon acceptance by the second user, the Voice over Internet Protocol application is launched to enable voice communication.

25. A method for learning language as claimed in claim 24, wherein the voice communication is enabled by the second user calling the first user.

26. A method for learning language as claimed in claim 23, wherein once voice communication is established between the first and second users, the scripted dialogue is presented to the user page by page.

27. A method for learning language as claimed claim 23, wherein the web pages are presented to the first user prior to invitation of the second user for a predetermined period of time, and an invitation cannot be sent until the first user has been presented with the web pages for the predetermined period of time.

28. A method for learning language as claimed in claim 21, wherein variations to the scripted dialogue are presented to the first and second users after the scripted dialogue has been presented.

29. A method for learning language as claimed in claim 28, wherein the variations are the scripted dialogue with portions removed.

30. A method for learning language as claimed in claim 28, wherein the variations are suggestions for free communication.

31. A method for learning language as claimed in claim 21, wherein a user must first log on to a server adapted to monitor and control the interaction of the users prior to being able to engage in communication with other users.

32. A method for learning language as claimed in claim 31, wherein relevant data about a user is recorded within a database associated with the server and may be viewed on a web page by other users to thereby enable the first user to select a suitable second user.

33. A method for learning language as claimed in claim 32, wherein a user is able to provide an indication of the performance of another user with whom a scripted dialogue comprising a role-play has been conducted and for the indications for a particular user to be averaged to provide a performance rating for said particular user.

34. A method for learning language as claimed in claim 31, wherein the second user is a teacher who provides time in tutoring the first user as a service for remuneration and wherein the server provides means to record the time spent by the teacher in tutoring the first user.

35. A method for learning language as claimed claim 34, wherein the server comprises means to collect payment from the respective first user for time engaged with the teacher and means to disburse payment to the teacher for time spent in tutoring the respective first user.

36. A method for learning language as claimed in claim 33, wherein the first user and the second user are students and a third user is a teacher who provides time in tutoring said first user and said second user as a service for remuneration and wherein the server provides means to record the time spent by the teacher in tutoring the first user and the second user.

37. A method for learning language as claimed in claim 36, wherein the server comprises means to collect payment from the respective first user and second user for time engaged with the teacher and means to disburse payment to the teacher for time spent in tutoring said first and second users.

38. A method for learning language as claimed in claim 31, wherein a user is able to search for a suitable teacher from a list of teachers who each have their average rating displayed on the same page.

39. A method for learning language as claimed in claim 31, wherein a user is able to provide an indication of the learning benefits of a scripted dialogue comprising a roleplay or discussion written by the particular writer and for the indications for a particular writer to be averaged to provide a performance rating for said writer.

40. A method for learning language as claimed in claim 39, wherein a user is able to search for a suitable writer from a list of writers who each have their average rating displayed on the same page
